(19) United States
(12) Patent Application Publication
(10) Pub. No.: US 2009/0272614 A1
(43) Pub. Date: Nov. 5, 2009

(54) Power Transmission Device

(75) Inventor: Shinichiro Watarai, Anjou-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-shi (JP)

(21) Appl. No.: 12/308,106

(22) PCT Filed: Jul. 12, 2007
(86) PCT No.: PCT/IB2007/001952

§ 371 Date: Dec. 8, 2008

(30) Foreign Application Priority Data
Jul. 18, 2006 (JP) 2006-196004

(51) Int. Cl. F16D 13/68

(52) U.S. Cl. 192/70.17

(57) ABSTRACT

A power transmission device includes a power input member that rotates when torque is applied thereto, a power output member that puts out the torque, and a transmitting member that transmits the torque of the power input member to the power output member. The power input member and the power output member have substantially the same axis of rotation. The power transmission device has twisting characteristics with which the magnitude of the torque generated from the power output member continuously changes along a curve, with respect to a relative angle of twist between the power input member and the power output member.

### BACKGROUND OF THE INVENTION

1. Field of the Invention

The invention relates to a power transmission device.

2. Description of the Related Art

The power transmission device transmits power from one device to another device. A clutch device of an automobile is an example of the power transmission device. The clutch device is mounted between a power source, such as an engine or a motor, and a transmission. The clutch device transfers the power from the power source to the transmission, or disconnects the power source and the transmission from each other.

A power transmission device includes a power input member and a power output member, and may further include a damper mechanism provided between the power input member and the power output member to absorb or alleviate shocks when the power input member or power output member undergoes sudden changes of load.

If a clutch pedal is abruptly operated when starting the automobile, for example, a large load is suddenly transmitted from the power source to the transmission through the power transmission device. In order to reduce shocks that would occur in this situation, the clutch device may be equipped with a damper mechanism. The damper mechanism may also, for example, alleviate rotational shocks when power is being transmitted.

Japanese Utility Model Application Publication No. S63-62633 describes a clutch disc that includes an output member having an output-shaft joining portion at its inner circumference, an input member disposed coaxially with the output member and spaced radially outward from the output member, and spring members and dampers which extend in radial directions and are alternately arranged at equal intervals in the circumferential direction.

Japanese Utility Model Publication No. H5-19612 describes a twisting mechanism of a clutch disc in which a clutch hub and a disc plate having clutch facings can be displaced (i.e., twisted) relative to each other on the same axis. In the twisting mechanism, first damper sheets are rotatably supported on the clutch hub via pins, and second damper sheets are rotatably supported on the disc plate via pins, while compression springs that extend in radial directions of the disc are interposed between the first and second damper sheets. In addition, contact portions that are in friction contact with both of the first and second damper sheets are formed.

Japanese Patent Application Publication No. 2002-266943 describes a clutch disc assembly including an input rotor, a spline hub, a damper portion, a large friction mechanism and a friction reducing mechanism. In the clutch disc assembly, the damper portion has second springs that connect the input rotor with the spline hub in the direction of rotation, and has twisting characteristics with respect to the positive side on which the input rotor is twisted to the driving side in the rotational direction relative to the spline hub and the negative side on which the input rotor is twisted to the side opposite to the driving side in the rotational direction. The large friction mechanism is able to produce friction when the input rotor and the spline hub rotate relative to each other and the elastic force of the second springs is applied to the mechanism, and the friction reducing mechanism ensures clearances between the second springs and the friction mechanism in the direction of rotation, with respect to either the positive side or the negative side of the twisting characteristics, so that the elastic force of the second springs is not applied to the friction mechanism within a certain range of angle.

Japanese Patent Application Publication No. JP-2001-304341 describes a clutch disc assembly that achieves multi-stage twisting characteristics. The clutch disc assembly has two plates, and the two plates have first windows and second Windows. A hub flange has first holes and second holes corresponding with the first windows and the second windows, respectively. A first elastic assembly is placed in the first window and the first hole, and has a first coil spring and a first sheet member. A second elastic assembly is placed in the second window and the second hole, and has a second coil spring and a second sheet member. With the first seat member being spaced from the first hole in the rotational direction, the first coil spring is not compressed in a region in which the angle of twist is small within a region in which the second coil spring is compressed, and the first coil spring is compressed in a region in which the angle of twist is large.

FIG. 24 explains the relationship between the relative angle of twist between the power input member and the power output member and the output torque in the clutch device of related art. In FIG. 24, the horizontal axis indicates the angle of twist, and the vertical axis indicates the output torque of the power output member. As the angle of twist increases, the torque generated from the power output member increases. The angle of twist and the output torque are in a direct proportional relationship. In the graph of FIG. 24, the relationship between the angle of twist and the output torque is expressed by straight lines.

In the clutch device shown in FIG. 24, the power input member and the power output member are arranged to be twisted relative to each other with the angle of twist being in a range of −θ1 to +θ1. When the angle of twist reaches −θ1 or +θ1, twisting stops, and the power applied to the power input member is entirely transmitted to and generated from the power output member.

In the related art, it is difficult to expand the range of the angle of twist. If the range of the angle of twist is small, gear noise or rattling of free rotating gears of the drive train may occur in the transmission connected to the clutch device. Namely, the clutch device according to the related art has poor noise-reduction efficiency with respect to the gear noise of the free rotating gears that do not contribute to transmission of the driving force.

In the clutch device of the related art, the relationship between the angle of twist and the output torque is expressed by straight lines, as shown in FIG. 24, which makes it difficult to adjust the magnitude of the output torque with respect to each angle of twist.

FIG. 25 also depicts the relationship between the relative angle of twist between the power input member and the power output member, and the output torque in the clutch device of related art. The clutch device as described in JP-A-2001-304341 has multi-stage twisting characteristics with which the rate of increase of the output torque with respect to the angle of twist changes at some midpoint.

Referring to FIG. 25 showing the twisting characteristics of the clutch device, the output torque increases at a relatively low rate in a region in which the angle of twist is relatively small, and the rate of increase of the output torque increases once the angle of twist reaches a certain position or point. In this type of clutch device, too, it is difficult to expand the angle of twist.

Furthermore, the clutch device having the multi-stage twisting characteristics suffers from low-frequency gear noise produced by gears that transmit drive power in the transmission, at points (where the lines are bent in the graph) at which the rate of increase of the output torque changes. For example, when the torque is substantially equal to 0, or when the vehicle is slowly decelerating, abnormal noises, such as gear noises, may occur due to spring-back at the bent points of the twisting characteristics.

### SUMMARY OF THE INVENTION

The invention provides a power transmission device that smoothly transmits power.

A power transmission device according to one aspect of the invention includes a power input member that rotates when torque is applied thereto, a transmitting member that transmits the torque applied to the power input member, and a power output member that outputs the torque applied to the power input member and transmitted by the transmitting member. The power input member and the power output member have substantially the same axis of rotation. The power transmission device has twisting characteristics with which the magnitude of the torque generated from the power output member continuously changes along a curve, with respect to a relative angle of twist between the power input member and the power output member.

The transmitting member may be provided in one of the power output member and the power input member, and may include a plurality of pressure members that press the other of the power output member and the power input member. The pressure members may be arranged at substantially equal intervals in a circumferential direction of the above-indicated one of the power output member and the power input member. The pressure members may be urged to press the other in radial directions. The magnitude of the torque generated from the power output member may vary with pressing force of the pressure members, which in turn varies with the relative angle of twist between the power input member and the power output member.

The other of the power output member and the power input member has a plurality of corners and a plurality of sides when viewed in a plane thereof. The pressure members may be positioned to contact with the respective sides of the other of the power input member and the power output member. The power input member may rotate relative to the power output member when a torque having a magnitude sufficient to cause the pressure members to override the corresponding corners of the other of the power input member and the power output member.

The other of the power output member and the power input member may have a plurality of corners and a plurality of sides when viewed in a plane thereof. The pressure members may be positioned so as to contact with the respective sides of the other of the power input member and the power output member. The power transmission device may further include a rotation preventing portion that inhibits the pressure members from overriding the corners of the other of the power input member and the power output member.

Each pressure member may include a contact portion that contacts with the other of the power output member and the power input member, and an elastic portion that biases the contact portion toward the other of the power input member and the power output member.

The other of the power output member and the power input member may be in the shape of a polygon as viewed in the plane thereof, and the sides of the other of the power input member and the power output member may be sides of the polygon.

The sides of the polygon of the other of the power output member and the power input member may be curved radially inward.

The pressure members may be coil springs and plate springs.

One of the power output member and the power input member may have an undulating portion in which high-level portions and low-level portions are continuously formed. The undulating portion may be formed in a surface of the above-indicated one member which faces to the other of the power output member and the power input member, in a circumferential direction about the axis of rotation. The transmitting member may be placed on the undulating portion, and may include a plurality of rolling members that are sandwiched between the power output member and the power input member, such that the rolling members roll. The other of the power output member and the power input member may include a pressure member that presses the rolling members against the undulating portion. The magnitude of the torque generated from the power output member varies with pressing force of the pressure member, which in turn varies with the relative angle of twist between the power input member and the power output member.

When the power input member receives power that causes the rolling members to override the high-level portions of the undulating portion, the power input member may rotate relative to the power output member.

The power transmission device may further include a rotation preventing portion that prevents the rolling members from overriding the high-level portions of the undulating portion.

The rolling members may be in the shape of spheres, cylinders or tapered cylinders.

The power output member may be movable in radial directions relative to the power input member to the extent that the power output member and the power input member rotate about substantially the same axis of rotation.

A power transmission device according to another aspect of the invention includes a power input member that rotates when torque is applied thereto, a power output member that outputs the torque applied to the power input member, and a transmitting member that transmits the torque applied to the power input member, to the power output member. The power input member and the power output member have substantially the same axis of rotation. The power input member rotates freely relative to the power output member when the power input member receives power whose magnitude is larger than a predetermined magnitude.

The power transmission device may have twisting characteristics with which the magnitude of the torque generated from the power output member periodically changes with respect to a relative angle of twist between the power input member and the power output member.

A power transmission device according to another aspect of the invention includes a power input member that rotates when torque is applied thereto, a plurality of pressure members that transmit the torque applied to the power input member, and a power output member that outputs the torque applied to the power input member and transmitted by the plurality of pressure members. The power output member has substantially the same axis of rotation as the power input member. The plurality of pressure members are attached to one of the power output member and the power input member, and presses the other of the power output member and the power input member in radial directions, such that the distance between the axis of rotation and positions where the pressure members contact the other of the power output member and the power input member varies with the relative angle of twist between the power input member and the power output member.

A power transmission device according to still another aspect of the invention includes a power input member that rotates when torque is applied thereto, a pressure member that transmits the torque applied to the power input member that outputs the torque applied to the power input member and transmitted by the plurality of pressure members. The power output member has substantially the same axis of rotation as the power input member. The pressure member is attached to one of the power output member and the power input member and is free from the other of the power output member and the power input member, and the pressure member is biased toward the other of the power output member and the power input member.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a schematic cutaway view of a clutch device according to a first embodiment of the invention;

FIG. 2 is an exploded perspective view schematically showing a first example of clutch disc of the first embodiment and a flywheel;

FIG. 3 is a schematic plan view showing a condition in which a clutch hub is mounted in a disc plate of the first clutch disc according to the first embodiment; FIG. 4 is an enlarged cross-sectional view schematically showing the disc plates and clutch hub of the first clutch disc of the first embodiment;

FIG. 5 is a schematic plan view useful for explaining the operation of the first clutch disc according to the first embodiment;

FIG. 6 is a graph useful for explaining the relationship between the angle of twist and the output torque in the first embodiment;

FIG. 7 is a graph useful for comparing the torque waveform of the clutch device of the invention upon sudden starting with that of a clutch device according to the related art;

FIG. 8 is an enlarged plan view schematically showing a clutch hub of a second example of clutch disc according to the first embodiment;

FIG. 9 is an enlarged plan view schematically showing a clutch hub of a third example of clutch disc according to the first embodiment;

FIG. 10 is an enlarged plan view schematically showing a clutch hub of a fourth example of clutch disc according to the first embodiment;

FIG. 11 is a graph useful for explaining the relationship between the angle of twist of the fourth clutch disc and the output torque in the first embodiment;

FIG. 12 is a schematic plan view showing a condition in which a clutch hub is mounted in a disc plate of a clutch disc according to a second embodiment of the invention;

FIG. 13 is an exploded perspective view schematically showing a clutch disc according to a third embodiment of the invention and a flywheel;

FIG. 14 is a schematic plan view showing a condition in which a clutch hub is mounted in a disc plate of the clutch disc according to the third embodiment;

FIG. 15 is a schematic plan view showing a condition in which a clutch hub is mounted in a disc plate of a clutch disc according to a fourth embodiment of the invention;

FIG. 16 is an exploded perspective view schematically showing a first example of clutch disc according to a fifth embodiment of the invention and a flywheel;

FIG. 17 is a schematic plan view showing a condition in which rolling members are placed in a disc plate of the first clutch disc of the fifth embodiment;

FIG. 18A is a schematic perspective view of a clutch hub of the first clutch disc according to the fifth embodiment;

FIG. 18B is a schematic perspective view of a clutch hub of a second example of clutch disc according to the fifth embodiment;

FIG. 19 is a schematic perspective view showing the clutch hub integrated with the disc plate in the fifth embodiment;

FIG. 20 is a schematic cross-sectional view of the first clutch disc of the fifth embodiment, which is taken along a plane that extends in the circumferential direction;

FIG. 21 is a schematic perspective view of another example of rolling member according to the fifth embodiment;

FIG. 22 is a schematic perspective view of a further example of rolling member according to the fifth embodiment;

FIG. 23 is an exploded perspective view schematically showing a clutch disc according to a sixth embodiment of the invention and a flywheel;

FIG. 24 is a first graph useful for explaining the relationship between the angle of twist of a clutch disc based on the related art and the output torque; and

FIG. 25 is a second graph useful for explaining the relationship between the angle of twist of a clutch disc based on the related art and the output torque.

### DETAILED DESCRIPTION OF THE EXAMPLE EMBODIMENTS

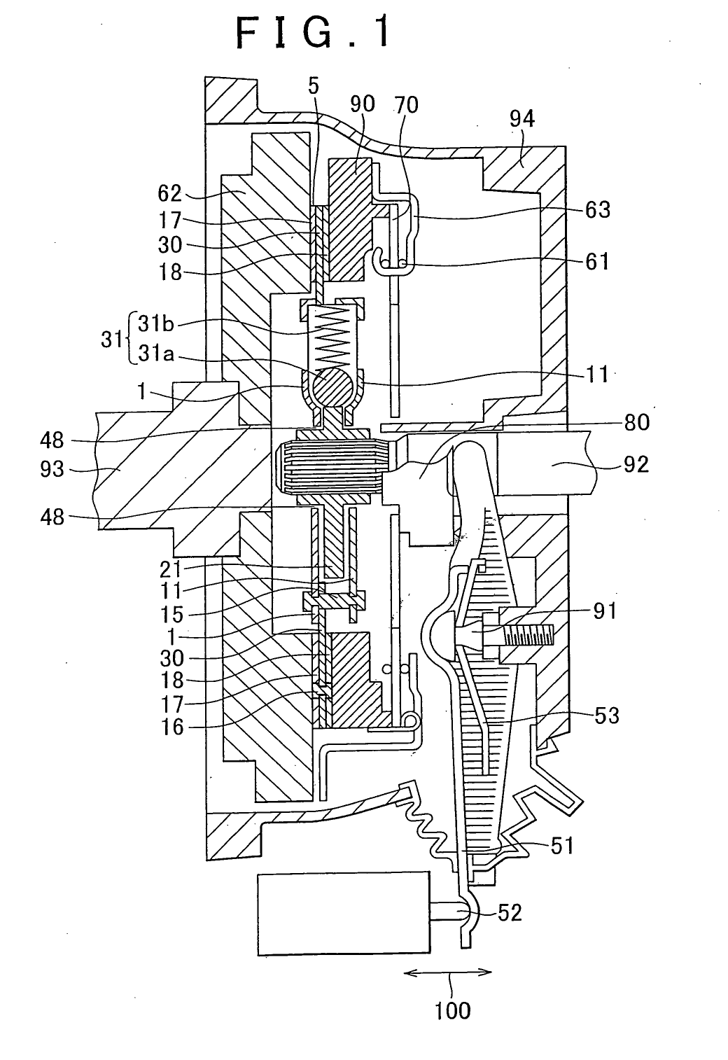

Referring to FIG. 1 through FIG. 11, a power transmission device according to a first embodiment of the invention will be described in detail. The power transmission device transmits power from one device to another device. In this embodiment, the power transmission device transmits torque from a power source to a target device. The power transmission device of this embodiment is in the form of a clutch disc of a clutch device installed on an automobile.

FIG. 1 is a cutaway side view of the clutch device according to the present embodiment. The clutch device of this embodiment is disposed between an engine and a transmission, and transmits power produced by the engine to the transmission or disconnects the power produced by the engine from the transmission. In this embodiment, the clutch device is a dry single plate clutch.

The clutch device includes a flywheel 62 having a disc-like shape. The flywheel 62 is fixed to the engine shaft 93 such that the flywheel 62 rotates with the engine shaft 93. The engine shaft 93 puts out torque of the engine. The torque of the engine is transmitted to the flywheel 62 via the engine shaft 93.

The clutch device has a housing (or casing) 94. A clutch release fork 51 is attached to the housing 94. The clutch release fork 51 is connected to a clutch release cylinder 52 and a spring 53, and is biased by the spring 53. The clutch release cylinder 52 is positioned so as to move the clutch release fork 51 against the bias force of the spring 53.

The clutch release cylinder 52 is adapted to push the clutch release fork 51 in a direction as indicated by arrow 100 in FIG. 1 so that the fork 51 pivots about a support 91. The clutch release fork 51 is in contact at its one end with the clutch release cylinder 52, and is in contact at the other end with a clutch release bearing 80. The clutch release fork 51 can pivot about the support 91. With the pivotal movement of the clutch release fork 51, the clutch release bearing 80 moves in the axial direction of the input shaft (i.e., engine shaft), so as to engage and disengage the clutch.

The clutch device includes a clutch disc 5 and a pressure plate 90 that presses the clutch disc 5. The clutch disc 5 and the pressure plate 90 are placed inside the housing 94. In this embodiment, the clutch disc 5 has a disc-like shape.

In the present embodiment, the pressure plate 90 has an annular shape. The pressure plate 90 applies uniform force to the clutch disc 5 so as to press the clutch disc 5 against the flywheel 62. A surface of the pressure plate 90 which contacts with the clutch disc 5 is formed as a flat surface.

The clutch disc 5 includes disc plates 1, 11. The disc plate 1 is disposed on the engine side, and the disc plate 11 is disposed on the transmission side. The disc plate 1 and the disc plate 11 are spaced apart from each other, and a spacer 15 is provided for determining the spacing or distance between the disc plate 1 and the disc plate 11. A clutch hub 21 that receives an input shaft 92 of the transmission is disposed at around the center of rotation of the clutch disc 5. The clutch hub 21 is placed between the disc plate 1 and the disc plate 11. The input shaft 92 serves to transmit drive torque to the transmission.

The clutch disc 5 further includes a disc spring 30 and clutch linings 17, 18. The disc spring 30 is also called “cushion plate”, and has certain elasticity. A radially inner region of the disc spring 30 is fixed to the disc plate 1, and a radially outer region of the disc spring 30 is sandwiched between the clutch linings 17, 18 and fixed in position.

The clutch linings 17, 18 serving as clutch facings are fixed to the disc spring 30. The clutch lining 17 is disposed on the engine side, and the clutch lining 18 is disposed on the transmission side. The clutch linings 17, 18 have an annular shape as their planar shape when viewed in a direction parallel to the axis of rotation of the clutch disc 5. The clutch linings 17, 18 and the disc spring 30 are fixed to each other with rivets 16 in a direction in which these members 17, 30, 18 are stacked together. The clutch linings 17, 18 are formed of a material having an appropriate coefficient of friction and excellent wear resistance and heat resistance. The coefficient of friction of the material for the clutch linings does not change with changes in the temperature when the clutch is engaged. More specifically, a resin-mold material or woven-mold material is used which contains glass fibers as a base and is subjected to resin finishing. The clutch linings may also be semi-metallic or ceramic linings for further improvements in the heat conductivity and strength.

A diaphragm spring 70 is a biasing member for pressing the clutch disc 5 against the flywheel 62 via the pressure plate 90. The diaphragm spring 70 is a clutch spring. The pressure plate 90 is pressed by the diaphragm spring 70 toward the clutch disc 5.

The diaphragm spring 70 of this embodiment is a single, disc-like spring, which is formed by stamping a spring steel plate and heat-treating the stamped plate. While the diaphragm spring 70 is used as a clutch spring in this embodiment, the clutch spring is not limited to this form, but may be in the form of a coil spring, for example.

The above-mentioned clutch release bearing 80 is positioned such that the bearing 80 contacts the diaphragm spring 70. The clutch release bearing 80 is formed to push the diaphragm spring 70. The clutch release bearing 80 is actuated by the clutch release fork 51 to move the input shaft 92 in the axial direction thereof without interfering with rotation of the input shaft 92.

The clutch release fork 51 is connected at one end to the clutch release bearing 80, and is connected at the other end to the clutch release cylinder 52. The clutch release fork 51 moves the clutch release bearing 80 in the axial direction. As the clutch release fork 51 pivots about the support 91, the clutch disc 5 is connected to and disconnected from the flywheel 62. The diaphragm spring 70 is housed in a clutch cover 63, and is held in position by pivot rings 61. The diaphragm spring 70 pivots about the pivot rings 61 and presses the pressure plate 90 against the clutch disc 5.

When the clutch release bearing 80 causes the diaphragm spring 70 to move in a certain direction, the direction of the movement is converted by the pivot rings 61, and the pressure plate 90 moves in the direction opposite to the direction of the movement of the clutch release bearing 80. For example, if the clutch release bearing 80 moves toward the flywheel 62, the pressure plate 90 moves away from the flywheel 62.

When the driver steps on the clutch pedal, this action is conveyed to the clutch release cylinder 52, and a distal end portion of the clutch release cylinder 52 pushes the clutch release fork 51. The clutch release fork 51 then pivots about the support 91, and a distal end portion of the clutch release fork 51 pushes the clutch release bearing 80. As a result, the clutch release bearing 80 moves toward the flywheel 62.

The movement of the clutch release bearing 80 is transmitted to the pressure plate 90 via the diaphragm spring 70. In FIG. 1, if the clutch release bearing 80 moves toward the flywheel 62, the direction of this movement is converted by the diaphragm spring 70, and the pressure plate 90 moves away from the flywheel 62. As a result, the force applied from the pressure plate 90 to the clutch disc 5 for pressing the clutch disc 5 against the flywheel 62 is reduced, and the clutch is disengaged.

When the driver releases the clutch pedal, the distal end portion of the clutch release cylinder 52 is retracted, and the clutch release bearing 80 moves away from the flywheel 62 under the bias force of the spring 53. The diaphragm spring 70 is then brought into its natural position under the bias force of the spring 70, so that the pressure plate 90 presses the clutch disc 5 against the flywheel 62, thereby to engage the clutch.

When the clutch disc 5 contacts the flywheel 62, the torque of the engine shaft 93 is transmitted to the clutch disc 5. The torque of the clutch disc 5 is then transmitted to the input shaft 92 via the clutch hub 21 disposed inside the clutch disc 5. In this manner, the torque of the engine shaft 93 is transmitted to the input shaft 92.

The clutch device of the present embodiment is a push-type clutch in which the pivot rings 61, serving as the pivot of the diaphragm spring 70, is located radially inward of the position of contact between the pressure plate 90 and the diaphragm spring 70. However, the invention is not limited to this form, but may be applied to a pull-type clutch device in which the pivot rings 61 are located radially outward of the position of contact between the pressure plate 90 and the diaphragm spring 70.

While the clutch of the embodiment is a hydraulic type, in which the clutch release fork 51 is driven by the clutch release cylinder 52, the clutch is not limited to this type. The invention may also be applied to a cable-type clutch device in which a cable is used to pull the clutch release fork 51. Also, while the clutch device of the present embodiment as explained above is a dry single plate clutch, the invention may be applied to a wet multiple-disc clutch.

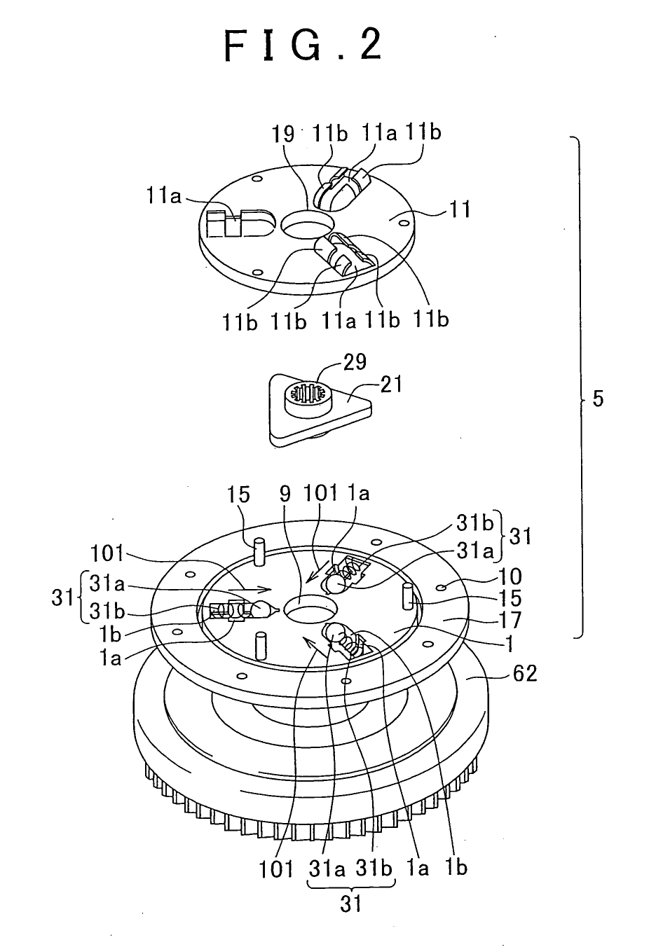

FIG. 2 is an exploded perspective view showing a portion of the clutch device of the present embodiment, which includes the flywheel 62 and the clutch disc 5. In FIG. 2, the disc spring 30 and the clutch lining 18 disposed on the transmission side are not illustrated. The flywheel 62 and the clutch disc 5 are arranged substantially coaxially with each other, such that the axes of rotation of the flywheel 62 and clutch disc 5 extend on substantially the same line. The flywheel 62 is formed in a circular shape when viewed from the bottom in FIG. 2, and the engine shaft 93 is inserted into the center of the circular flywheel 62.

The clutch disc 5 as a first example of clutch disc according to the present embodiment includes disc plates 1, 11 serving as a power input member, and a clutch hub 21 serving as a power output member. In operation, the torque of the disc plate 1 is transmitted to the clutch hub 21 via pressure members 31 serving as transmission members.

The disc plates 1, 11 of this embodiment have a disc-like shape. In this embodiment, the disc plates 1, 11 have substantially the same shape, and are positioned to be opposed to each other. Each of the disc plates 1, 11 has holes 1a, 11a, which extend in radial directions when viewed from the top in FIG. 2. Each of the holes 1a, 11a has a generally rectangular shape when viewed from the top in FIG. 2.

Each of the disc plates 1, 11 has a hub insertion hole 9, 19. The clutch hub 21 is sandwiched by and between the disc plates 1, 11. A shaft receiving portion 29 of the clutch hub 21 is inserted into the hub insertion holes 9, 19. The hub insertion holes 9, 19 are formed on the axis of rotation of the disc plate 1. The hub insertion holes 9, 19 have a circular shape when viewed from the top in FIG. 2. In this embodiment, the inside diameter of the hub insertion holes 9, 19 is slightly larger than the outside diameter of the shaft receiving portion 29. The hub insertion holes 9, 19 of this embodiment are formed such that a clearance of about 1 mm is created between the shaft receiving portion 29 and each of the hub insertion holes 9, 19.

The clutch disc 5 according to the present embodiment includes the pressure members 31 that press the clutch hub 21. The pressure members 31 are placed in the holes 1a, 11a of the disc plates 1, 11. The pressure members 31 are biased toward the axis of rotation of the disc plate 1, as indicated by arrow 101 in FIG. 2, namely, are biased in such a direction as to press the clutch hub 21. The pressure members 31 are arranged to extend in radial directions of the disc plate 1.

Each of the pressure members 31 has a contact portion 31a for contact with the clutch hub 21. In this embodiment, the contact portion 31a is in the shape of a sphere. The pressure member 31 also has an elastic portion 31b for biasing the contact portion 31a toward the clutch hub 21. In this embodiment, the elastic portion 31b is a coil spring.

It is to be understood that the pressure member is not limited to this form or configuration, but may be otherwise formed provided that it can press the clutch hub. For example, the contact portion is not necessarily spherical, but may be in the shape of a column having a semi-spherical end portion for contact with the clutch hub. The contact portion may also be in the form of a roller. The contact portion itself may be able to rotate.

The disc plates 1, 11 of this embodiment have guide walls 1b, 11b. The guide walls 1b, 11b are in the form of walls that protrude outward from the edges of the holes 1a, 11a, respectively. The guide walls 1b, 11b are formed along the shape of the contact portion 31a, and support the contact portion 31a and elastic portion 31b of the corresponding pressure member 31. Thus, the pressure members 31 are sandwiched by and between the guide walls 1b, 11b. The guide walls 1b, 11b extend in radial directions of the disc plate 1.

Between the opposing guide walls lb and guide walls 11b, a space that allows movement of the contact portion 31a of the pressure member 31 and a space that accommodates the elastic portion 31b are formed. The elastic portion 31b is fixed at one end to the contact portion 31a, and is in contact at the other end with the inner wall of the corresponding hole 1a, 11a. The guide walls 1b and the guide walls 11b support the contact portion 31a such that the contact portion 31a can slide in a radial direction between the walls 1b, 11b.

The clutch hub 21 is generally in the form of a plate, and is positioned such that the pressure members 31 abut on end faces of the clutch hub 21 at the outer periphery thereof. In this embodiment, each of the end faces of the clutch hub 21 assumes a flat surface. The clutch hub 21 has the shaft receiving portion 29 that protrudes axially outward from a flat portion of the hub 21. The shaft receiving portion 29 has an insertion hole through which the input shaft 92 is inserted, as shown in FIG. 1.

The clutch lining 17 is formed with rivet holes 10. The above-mentioned rivets 16 are placed in the rivet holes 10, so that the clutch lining 17, disc spring 30 and the clutch lining 18 are stacked together and fixed to each other, as shown in FIG. 1.

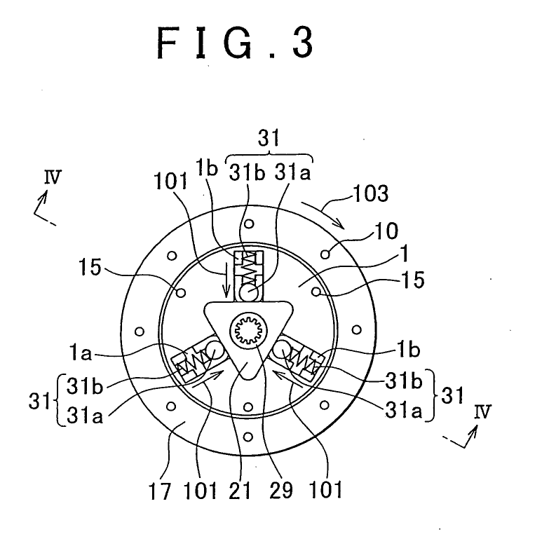

FIG. 3 is a schematic plan view showing the clutch hub mounted in the disc plate according to the present embodiment. The clutch hub 21 of this embodiment is generally in the shape of a regular triangle when viewed in the sheet plane of FIG. 3. The clutch hub 21 having a triangular shape has corner portions that are rounded or arc-shaped.

FIG. 3 shows a neutral condition of the clutch disc 5 in which the clutch hub 21 is placed in a neutral position. In the present embodiment, the neutral condition means a condition in which no load is applied to both the power input member and the power output member, and the neutral position indicates the position of the clutch hub 21 established when the clutch disc 5 is in the neutral condition. When placed in the neutral position, each side of the triangle of the clutch hub 21 extends in a direction substantially perpendicular to the direction in which the corresponding pressure member 31 extends. The pressure members 31 are positioned so as to press the respective end faces of the clutch hub 21. With the pressure members 31 pressing the clutch hub 21 as indicated by arrows 101 in FIG. 3, the clutch hub 21 is held in the neutral position.

In the present embodiment, the number of the pressure members 31 placed in the clutch disc 5 matches the number of sides of the polygonal (e.g., triangular) shape in which the clutch hub 21 is formed. Thus, in this embodiment the clutch disc 5 has three pressure members 31. The pressure members 31 are arranged at equal intervals along the circumferential direction of the clutch disc 5. In this embodiment, the pressure members 31 are arranged at intervals of about 120° along the circumferential direction of the clutch disc 5. Namely, the pressure members 31 are oriented in the clutch disc 5 such that extensions of the adjacent ones of the pressure members 31 form an angle of about 120°.

The pressure members 31 are arranged to extend in radial directions when viewed in the sheet plane of FIG. 3. The pressure members 31 are positioned so as to press the clutch hub 21 in radial directions toward the center of rotation of the disc plate 1. In other words, the pressure members 31 are positioned so as to press the clutch hub 21 in directions perpendicular to the axis of rotation of the clutch disc.

FIG. 4 is an enlarged, cross-sectional view schematically showing the clutch disc according to the present embodiment. FIG. 4 is a cross-sectional view taken along line IV-IV in (of) FIG. 3, as viewed from the arrows (IV, IV). The pressure member (Each of the pressure members) 31 presses the clutch hub 21 toward the axis of rotation of the input shaft 92, as indicated by arrow 101 (in FIG. 4). The pressure member 31 is sandwiched between the disc plate 1 and the disc plate 11. The clutch hub 21 rotates as a unit with the input shaft 92.

Referring to FIG. 3 and FIG. 4, the clutch hub 21 moves relative to the disc plates 1, 11. The disc plates 1, 11 and the clutch hub 21 have substantially the same axis of rotation. The clutch hub 21 rotates relative to the disc plates 1, 11.

Referring to FIG. 3 and FIG. 4, in the clutch disc 5 of this embodiment, the biasing force of the pressure members 31 acts on the clutch hub 21 so as to urge the clutch hub 21 to return to the neutral position. When the disc plate 1 rotates in a direction as indicated by arrow 103 in FIG. 3, the clutch hub 21 is brought into a twisted position relative to the disc plate 1.

When the disc plate 1 rotates, the force applied from the pressure members 31 to the clutch hub 21 to press the clutch hub 21 causes the clutch hub 21 to rotate. At this time, the angle of twist is determined depending upon the force with which the pressure members 31 press the clutch hub 21. In other words, the angle of twist depends on the magnitude of the reaction force applied from the clutch hub 21 to the disc plate 1.

In the clutch disc 5 of the present embodiment, when certain torque is applied to the disc plate 1, the disc plate 1 unlimitedly rotates relative to the clutch hub 21. When the disc plate 1 receives power large enough to cause the pressure members 31 to override the corresponding corners of the clutch hub 21, the disc plate 1 rotates relative to the clutch hub 21.

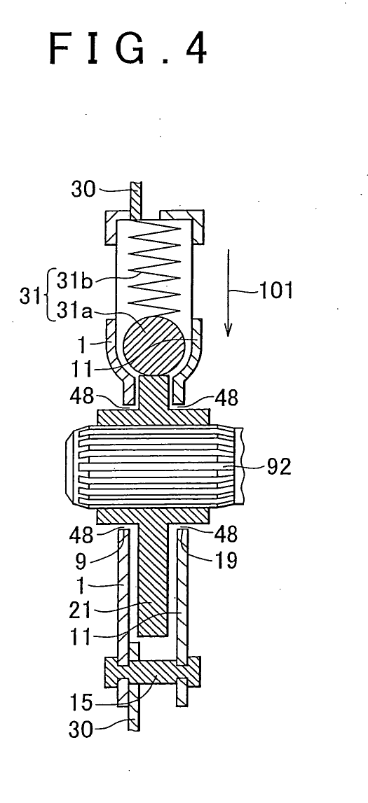

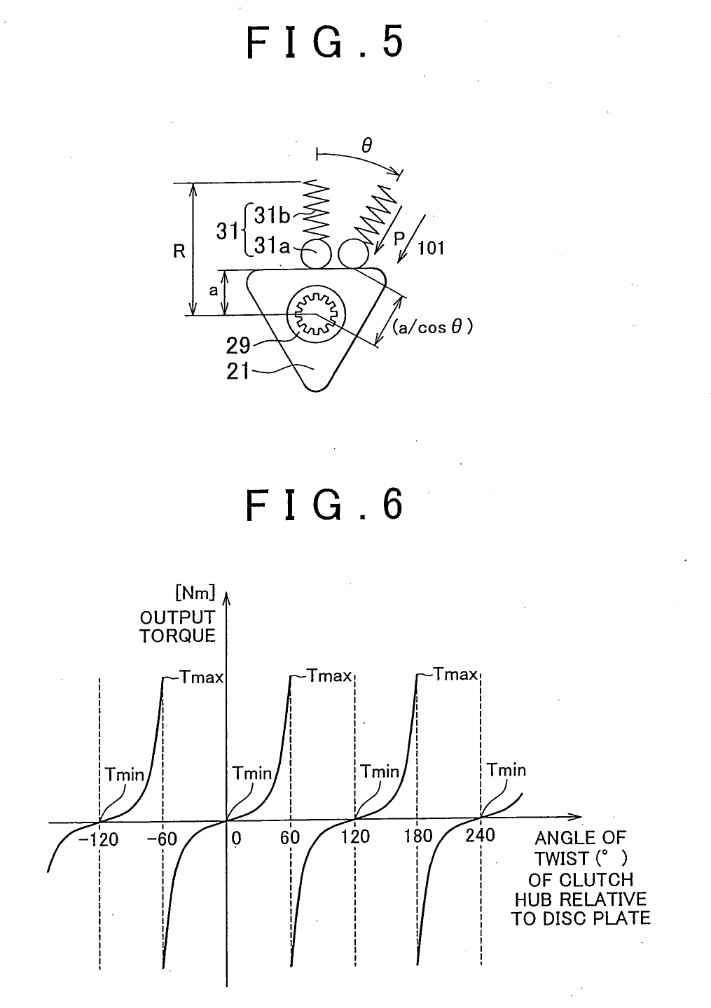

FIG. 5 is a schematic plan view that explains the output torque produced when the clutch hub is brought into a twisted condition relative to the disc plate with an angle θ of twist. FIG. 5 illustrates only one pressure member positioned relative to the clutch hub before and after displacement of the disc plate 1.

When the clutch hub 21 is in the neutral condition, the side of the clutch hub 21 having a triangular shape extends in a direction substantially perpendicular to the direction of extension of the pressure member 31. If the disc plate 1 is brought into contact with the flywheel 6, the torque is applied to the disc plate 1. As the disc plate 1 rotates, the angle θ of twist is created between the disc plate 1 and the clutch hub 21. Here, the case where the angle θ of twist is created will be examined in greater detail. In this specification, the angle of twist means the angle of rotation from the neutral position.

The amount of compression ΔX₀ of the elastic portion 31b of the pressure member 31 in question when the angle of twist is equal to 0° (i.e., when the clutch hub 21 is in the neutral position) is expressed by the following equation (1):

ΔX0=X0−(R−a) (1)

where X₀ is free length of the coil spring as the elastic portion 31b, “a” is distance between the position of the axis of rotation of the clutch hub 21 (the center of gravity taken in the planar shape of the hub 21 in this embodiment) and one side of the triangle as the planar shape of the hub 21, and R is distance between the position of the axis of rotation of the clutch hub 21 and the distal end of the elastic portion 31b when the clutch hub 21 is in the neutral position.

Next, the amount of compression ΔX of the elastic portion 31b when the angle of twist is equal to θ is expressed by the following equation (2):

$$Δ X = Xo - R + \frac{a}{cos θ} \qquad ( 2 )$$

Here, the pressing force F of the elastic portion 31b is expressed by the following equation (3) where k is spring constant of the coil spring as the elastic portion 31b:

F=k×ΔX (3)

The pressing force F is applied to the clutch hub 21 in a direction as indicated by arrow 101 in FIG. 5. If friction between the clutch hub 21 and the disc plate 1 is ignored, a component of the pressing force applied in the direction of rotation is expressed by F×tan θ. In this case, the radius of application is (a/cos θ). Thus, the output torque T derived from twisting is expressed by the following equation (4):

$$\begin{matrix}T = F \times tan θ \times \frac{a}{cos θ} \\ = k \times {a}^{2} \times ( \frac{Xo - R}{a} + \frac{1}{cos θ} ) \times \frac{sin θ}{{cos}^{2} θ}\end{matrix} \qquad ( 4 )$$

In this embodiment, when the angle of twist θ is equal to 60°, the contact portion 31a of the pressure member 31 is placed at a corner portion of the planar shape of the clutch hub 21, and the output torque T reaches its maximum. The maximum output torque Tₘₐₓ is expressed by the following equation (5):

$$T max = k \times {a}^{2} \times ( \frac{Xo - R}{a} + 2 ) \times 3.46 \qquad ( 5 )$$

The graph of FIG. 6 explains the relationship between the angle of twist of the clutch hub relative to the disc plate and the output torque generated from the clutch hub in this embodiment and shows the twisting characteristics of the clutch hub. In FIG. 6, the horizontal axis indicates the angle of twist of the clutch hub relative to the disc plate, and the vertical axis indicates the output torque generated from the clutch hub. The output torque on the vertical axis corresponds with the reaction force applied from the clutch hub to the disc plate.

In the region where the angle of twist is in the range of 0° to 120°, the output torque is at the minimum when the angle of twist is equal to 0° (i.e., when the clutch hub is in the neutral position), and reaches the maximum when the angle of twist is equal to 60°. When the input torque applied to the power input member is equal to or smaller than the maximum output torque Tₘₐₓ in FIG. 6, the torque of the power input member is transmitted as it is to the power output member. When the input torque exceeds the maximum output torque Tₘₐₓ, the disc plate 1 rotates relative to the clutch hub 21. Namely, at least part of the torque is not transmitted to the clutch hub 21, and the disc plate 1 turns free relative to the clutch hub 21. The clutch disc according to the present embodiment has periodic twisting characteristics that vary periodically with the angle of twist. In FIG. 6, one period of the angle of twist is 120°, namely, a certain pattern of twisting characteristics is repeated every 120°.

When a large torque is suddenly applied to the disc plate 1, the disc plate 1 turns freely so that at least part of the torque is not transmitted to the clutch hub 21 and the input shaft 92. For example, if the disc plate 1 is suddenly brought into contact with the flywheel 62 while the flywheel 62 is rotating at a high speed, the disc plate 1 turns freely relative to the clutch hub 21.

Thus, the clutch disc according to the present embodiment functions as a torque limiter. When torque of a certain magnitude or larger is applied to the power input member, the clutch disc inhibits at least part of the torque from being transmitted to the power output member. Thus, the clutch disc is able to smoothly transmit power while suppressing shocks that would occur when large torque is applied to the disc plate or the load of the clutch hub is suddenly varied. When the load of the power output member is suddenly varied, at least part of the torque is inhibited from being transmitted to the power output member. The magnitude of the maximum output torque may be easily adjusted by changing the shape or size of the clutch hub or changing the elasticity of the elastic portions.

The power transmission device of the present embodiment is the clutch disc, which is connected to the transmission via the clutch hub as the power output member. In this embodiment, the maximum output torque applied to the transmission can be limited to a desired magnitude, thus providing an increased margin of the strength of drive-train components, such as a transmission.

If the clutch is suddenly engaged through an erroneous operation while the engine speed is high, for example, torque that is at least twice as large as the engine torque may be applied to the components of the drive train including, for example, the transmission, a propeller shaft, differential gears and a driveshaft. On the assumption that the clutch might be erroneously operated, the components of the drive train were required to be manufactured with sufficiently high strength so that the components can withstand large input torque. In the clutch device including the clutch disc of the present embodiment, on the other hand, the upper limit of the input torque transmitted to the transmission is determined in the manner as described above, thus providing an increased margin of the strength of the drive-train components. Consequently, the drive-train components can be reduced in size.

For example, the torque applied to the drive-train components may become equal to or larger than the torque produced by the power source, such as an engine, even during normal operation. In view of this situation, the drive-train components preferably have a margin of the strength that is at least about 10 to 20% of the nominal strength. Accordingly, the torque transmitted to the clutch hub is set to be no less than about 1.1 times and no more than about 1.2 times as large as the torque produced by the engine, thus providing an increased margin of the strength of the drive-train components.

In the related art, if the transmission fails due to an excessive load applied thereto, the transmission itself needs to be replaced with a new one, which requires extensive repair. Therefore, inexpensive components are formed with intentionally reduced strength, as compared with more expensive devices, such as a transmission, so that the inexpensive components are more likely to be broken than the expensive devices. For example, relatively inexpensive components, such as a driveshaft, may be formed with lower strength than the transmission. If any device is broken due to an excessive load, the inexpensive components fail before the transmission is broken. However, if the input torque applied to the drive train is limited in the above-described manner according to the invention, there is no need to form some components with reduced strength so that these components are more likely to be broken than the transmission and other expensive devices, thus making it easier to design the drive train.

In conventional automobiles, an orifice may be disposed in an oil channel or channels inside a hydraulic system for moving the clutch disc, so as to prevent the clutch from being suddenly or abruptly engaged. In the presence of the orifice limiting the amount of the oil flowing therethrough, it is possible to avoid rapid movement of the clutch disc, thereby to prevent the disc plate and the flywheel from abruptly contacting with each other.

In the above-described structure in which the orifice is disposed in the hydraulic system, however, the viscosity of the oil may increase when the temperature of the outside air is low, and it may take an excessively long time to move the disc plate to a desired position. On the other hand, the power transmission device of the invention does not require a device or means (e.g., orifice) for preventing sudden engagement of the clutch, and thus assures stable performance even if the temperature of the outside air is low.

The clutch disc according to the present embodiment has twisting characteristics as shown in FIG. 6, in which the output torque represented by curves continuously changes from the neutral position. In other words, the clutch disc of this embodiment has stepless twisting characteristics having no stepped portions. The clutch disc has similar twisting characteristics when the angle of twist of the clutch hub is in a negative region, which characteristics are symmetrical to the twisting characteristics obtained when the angle of twist is in a positive region.

For example, in a region where the angle of twist of the clutch hub relative to the disc plate is in the range of 0° to 60°, the coil spring as the elastic portion contracts by a larger degree and the pressing force of the pressure member increases as the angle of twist increases. The output torque increases with the increase of the pressing force of the pressure member. In this case, the output torque changes continuously along a curve having no stepped portions.

With the output torque thus continuously changing, power. is smoothly transmitted to the transmission connected to the clutch hub. It is thus possible to effectively suppress gear noise of drive gears that would be otherwise generated from the transmission due to stepped portions of a line representing changes of the output torque.

In the present embodiment, the curve representing the output torque of the clutch disc has a relatively small gradient in the vicinity of the neutral position, and the gradient gradually increases as the output torque gets close to the maximum output torque. In a region in the vicinity of the neutral position in which the clutch disc is connected to the flywheel during normal operation, the gradient of the curve representing the output torque is small. Therefore, power is gradually transmitted so that the clutch disc and the flywheel are smoothly connected to each other. For example, power is smoothly transmitted to the transmission even if the clutch pedal is operated relatively quickly.

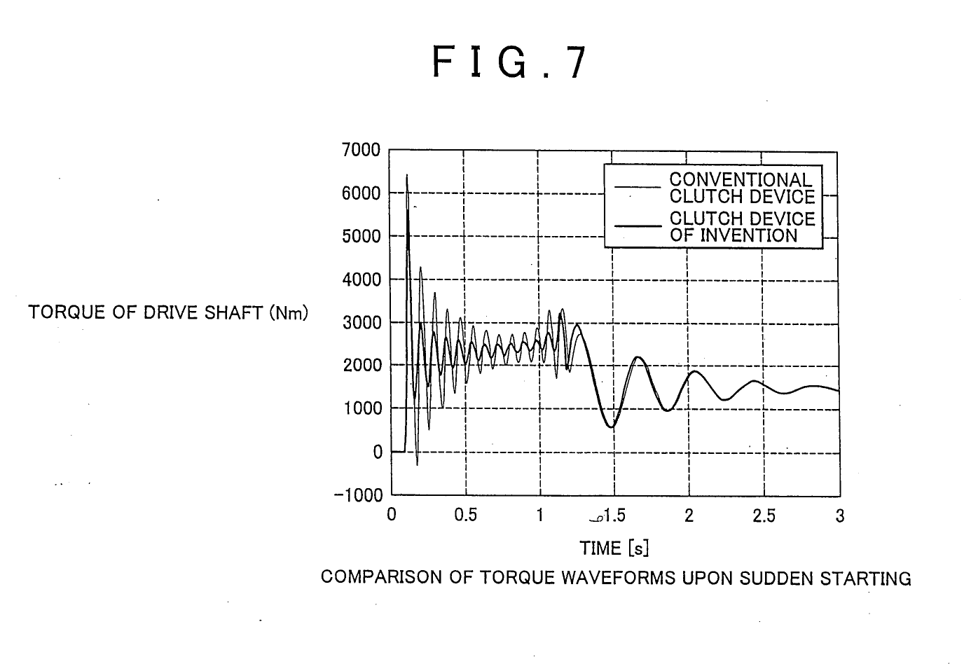

FIG. 7 explains the condition where the flywheel and the disc plate are suddenly or abruptly connected in the clutch device of the present embodiment. In FIG. 7, the horizontal axis indicates time, and the vertical axis indicates torque applied to the driveshaft as a part of the drive train. The graph of FIG. 7 shows a condition where power applied to the disc plate does not cause the disc plate to rotate relative to the clutch hub, namely, a condition where the input torque is smaller than the maximum output torque Tₘₐₓ.

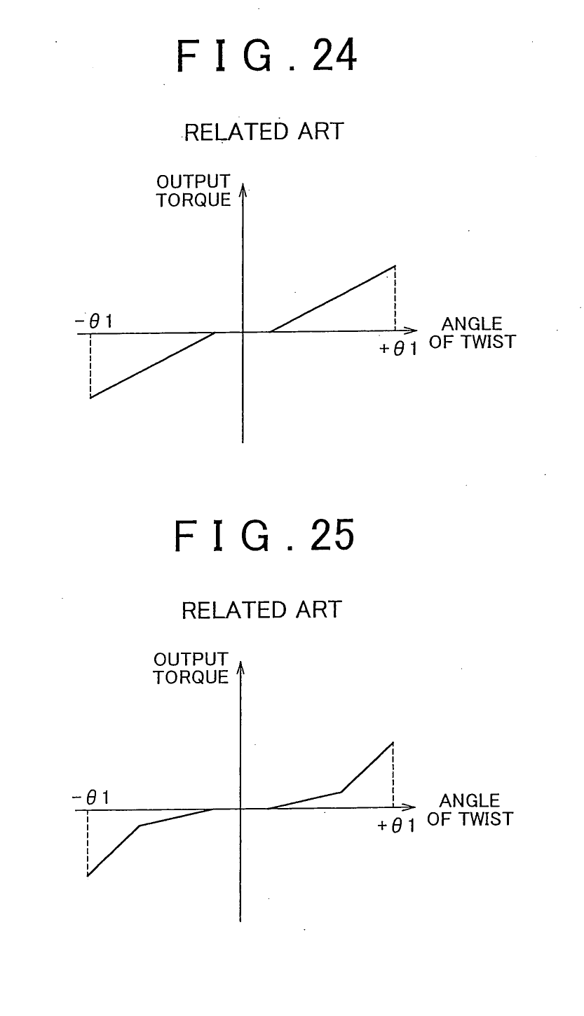

As shown in FIG. 7, in the clutch device according to the invention, fluctuations in the torque applied to the driveshaft are reduced (namely, vibrations due to the fluctuations in the torque are damped) more quickly than those of the conventional clutch devices. In the conventional clutch devices, the output torque varies along a straight line or lines with respect to the angle of twist of the clutch hub, as shown in FIG. 24 and FIG. 25, and, therefore, the rate of reduction of the fluctuations in the torque (or damping force for damping vibrations due to the fluctuations in the torque) has a proportional relationship with the angle of twist. In the clutch device of this embodiment, on the other hand, the rate of change of the output torque increases as the angle of twist increases. Therefore, the clutch device of this embodiment has a high capability of damping the vibrations due to the fluctuations in the torque, namely, is able to reduce the vibrations in a short time.

The clutch disc according to the present embodiment provides an increased range of the angle of twist of the clutch hub. In this embodiment, the angle of twist ranges from the neutral position (0°) to ±60°. By widening the range of the angle of twist, it is possible to effectively reduce gear noise of free rotating gears of the drive train, which would otherwise occur in the transmission connected to the clutch device.

In the present embodiment, the twisting characteristics are changed depending upon the pressing force of the pressure members, which varies with the relative angle of twist between the power input member and the power output member. Thus, the twisting characteristics may be easily adjusted. For example, the output torque characteristics may be adjusted by changing the shape or size of the clutch hub as the power output member, or changing the pressing force or pressing method of the pressure members. While the clutch hub pressed by the pressure members is formed generally in the shape of a regular triangle as viewed in its plane in the present embodiment, the clutch hub is not limited to this shape or configuration, but may be formed in any desired shape.

In the present embodiment, clearances 48 are formed between the clutch hub 21 and the hub insertion holes 9, 19, as shown in FIG. 3 and FIG. 4. Each of the clearances 48 of this embodiment is about 1 mm. In this embodiment, the axis of rotation of the clutch hub 21 is slightly offset from the axis of rotation of the disc plates 1, 11 within a range in which the clutch hub 21 and the disc plates 1, 11 rotate about substantially the same axis. Here, the range of substantially the same axis of rotation means a range that permits transmission of power between the disc plates 1, 11 and the clutch hub 21. The clutch hub 21 rotates at a position where its axis of rotation is slightly offset from that of the disc plates 1, 11. Namely, the clutch hub 21 can move in radial directions relative to the disc plates 1, 11. Thus, the clutch device of this embodiment has a certain degree of flexibility in movement of the clutch hub 21 in the radial directions.

In the clutch device, the axis of the engine shaft 93 and the axis of the input shaft 92 may slightly deviate from each other (as shown in FIG. 1). For example, about 0.3 mm of deviation may appear between the axes of these shafts 93, 92. Due to the deviation, extraordinary wear of the clutch. hub or gear noise (e.g., rattles) may occur. In the clutch device of this embodiment, the clutch hub 21 has a certain degree of flexibility in its movement in the radial directions, and therefore, extraordinary wear of the clutch hub 21 and gear noise in the transmission can be suppressed or prevented.

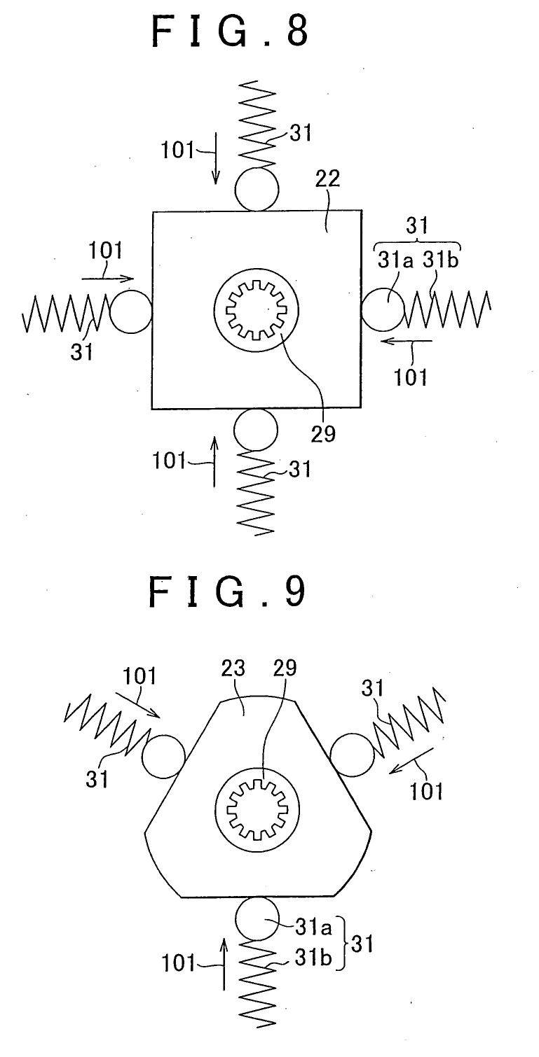

FIG. 8 is a schematic plan view of a clutch hub of a second example of clutch disc according to the present embodiment. FIG. 8 shows the clutch hub when placed in the neutral position relative to the disc plates. The second clutch disc has a clutch hub 22. The clutch hub 22 is formed generally in the shape of a square as viewed in the plane of FIG. 8.

The pressure members 31 fixed to the disc plates are positioned so as to face the respective sides of the planar shape (i.e., square) of the clutch hub 22 when it is in the neutral position. In the second clutch disc, four pressure members 31 are provided. The pressure members 31 are arranged at equal intervals along the circumferential direction of the disc plates, such that extensions of the adjacent ones of the pressure members 31 form an angle of 90° therebetween.

In the second clutch disc, the range of the angle of twist is reduced, while the number of the pressure members is increased, as compared with the first example of clutch disc. Thus, the pressing force applied from the pressure members for pressing the clutch hub 22 may be increased, and the maximum output torque Tₘₐₓ achieved when the clutch hub rotates relative to the disc plates is greater.

FIG. 9 is a schematic plan view of a clutch hub of a third example of clutch disc according to the present embodiment. FIG. 9 shows the clutch hub when placed in the neutral position relative to the disc plates. The third clutch disc has a clutch hub 23. The clutch hub 23 is in the shape of a partially removed circle having three flattened portions, or a generally triangular shape, as viewed in the plane of FIG. 9.

The pressure members 31 placed in the disc plates are positioned so as to face the flattened portions of the clutch hub 23 when it is in the neutral position. In the third clutch disc, three pressure members 31 are provided. The pressure members 31 are arranged at equal intervals along the circumferential direction of the disc plates, such that the pressure members 31 extend in radial directions. Extensions of the adjacent ones of the pressure members 31 form an angle of about 120° therebetween. Thus, the clutch hub may employ the shape of a partially removed or flattened circle as its planar shape.

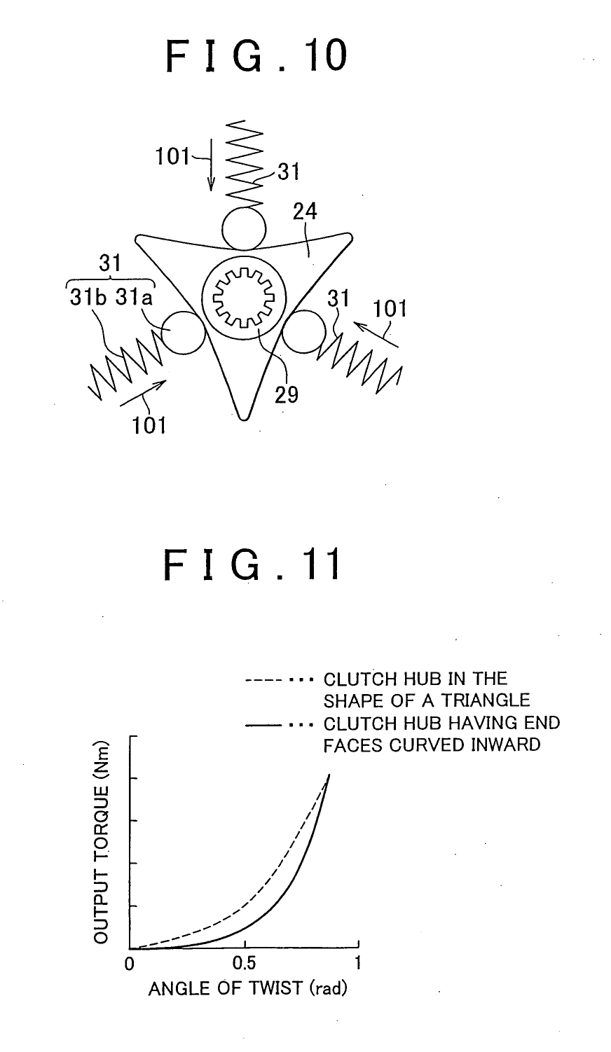

FIG. 10 is a schematic plan view of a clutch hub of a fourth example of clutch disc according to the present embodiment. FIG. 10 shows the clutch hub when placed in the neutral position relative to the disc plates. The fourth clutch disc has a clutch hub 24 having a generally triangular shape as viewed in the plane of FIG. 10. The clutch hub 24 is formed such that each side of the triangle as its planar shape is bowed inward (i.e., toward the center of the clutch hub 24). Namely, each end face of the clutch hub 24 is curved inward.

The pressure members 31 are positioned so as to face the respective curved end faces of the clutch hub 24 when it is in the neutral position. The fourth clutch disc is provided with three pressure members 31. The pressure members 31 are arranged at equal intervals such that extensions of the adjacent ones of the pressure members 31 form an angle of about 120° therebetween.

FIG. 11 is a graph that explains the relationship between the angle of twist of the fourth clutch device according to the present embodiment and the output torque. In FIG. 11, the horizontal axis indicates the angle of twist, and the vertical axis indicates the output torque. Also in FIG. 11, the broken line indicates characteristics of the clutch disc in which the clutch hub is in the shape of a regular triangle as viewed in its plane, and the solid line indicates characteristics of the clutch disc in which the clutch hub is in the shape of a regular triangle as viewed in its plane, and each side of the triangle is curved inward.

With each side of the regular triangle of the clutch hub being curved inward, the rate of change of the output torque in the vicinity of the neutral position (at which the angle of twist is equal to 0°) is reduced, as compared with the case where each side is not curved. Thus, if the clutch hub is in the shape of a polygon as viewed in its plane, and each side of the polygon is curved inward, the output torque changes at a reduced rate in a region where the angle of twist is small, and the rate of change of the output torque increases as the angle of twist increases.

While each side of the clutch hub having a polygonal shape as viewed in its plane is curved radially inward in the fourth example of clutch disc according to the present embodiment, the invention is not limited to this form. Instead, the clutch hub may be formed such that each side is curved radially outward.

It is also to be understood that the clutch hub may have any desired planar shape other than the shape of a polygon. By changing the planar shape of the clutch hub, it is possible to change the range of the angle of twist and/or adjust the twisting characteristics. It is also possible to set the maximum output torque Tₘₐₓ to a desired magnitude while adjusting the twisting characteristics, by changing the size or dimensions of the planar shape of the clutch hub, or changing the shape of each corner portion of the clutch hub.

In the illustrated embodiment, the pressure members are placed in the disc plates as the power input member, such that the pressure members press the clutch hub as the power output member. However, the invention is not limited to this form or arrangement, but the pressure members may be placed in the power output member, such that the pressure members press the power input member.

While the power transmission device is in the form of a clutch disc of a clutch device installed on an automobile, by way of example, in the illustrated embodiment, the invention is not limited to this form, but may be equally applied to any type of power transmission device. For example, the invention may be applied to a power transmission device adapted to transmit power from a motor as a power source to a transmission in an industrial manufacturing apparatus.

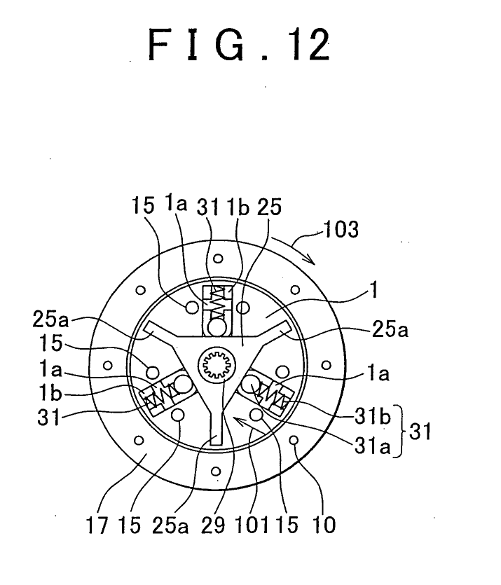

Referring next to FIG. 12, a power transmission device according to a second embodiment of the invention will be described. The power transmission device of this embodiment is in the form of a clutch disc of a clutch device installed on an automobile. The clutch disc of this embodiment is different from the first example of clutch disc of the first embodiment in terms of the shape of the clutch hub.

FIG. 12 is a schematic plan view showing a clutch hub mounted in a disc plate in the clutch disc of the present embodiment. The clutch disc of this embodiment includes a disc plate 1 as a power input member. Spacers 15 are disposed on the disc plate 1 so as to protrude upright from a major surface of the disc plate 1. In this embodiment, the spacers 15 are located on the opposite sides of each of the holes 1a of the disc plate 1.

The clutch disc according to the present embodiment includes a clutch hub 25 as a power output member. The clutch hub 25 is formed in the shape of a generally regular triangle as viewed in its plane. The clutch hub 25 has protrusions 25a formed at around respective apexes of the triangle as the planar shape of the hub.

The protrusions 25a are formed so as to protrude from respective corners of the planar shape (e.g., triangle) of the clutch hub 25. The protrusions 25a extend radially outward of the clutch hub 25. When the clutch hub 25 rotates relative to the disc plate 1, the protrusions 25a are brought into contact with the corresponding spacers 15 on the disc plate 1.

The clutch disc according to the present embodiment is provided with rotation preventing portions formed so as to prevent the pressure members 31 from overriding the corners of the clutch hub 25. The rotation preventing portions include the spacers 15 and the protrusions 25a. In this embodiment, the protrusions 25a of the clutch hub 25 are brought into abutment with the spacers 15 so that the clutch hub 25 does not rotate relative to the disc plate 1 by an angle larger than a predetermined angle of rotation.

The clutch disc according to the present embodiment functions to stop the clutch hub, and is adapted to stop the twisting motion when the disc plate has a certain angle of twist relative to the clutch hub. Thus, the disc plate is prevented from rotating unlimitedly relative to the clutch disc. In the clutch disc of this embodiment, when large power is applied to the power input member, the power output member outputs the entire torque received. In this embodiment, too, the clutch disc shows stepless twisting characteristics.

While the rotation preventing portions of the present embodiment include the protrusions of the clutch hub and the spacers, the rotation preventing portions are not limited to this form or arrangement. Rather, the rotation preventing portions may take any other form as desired provided that it can stop rotation of the disc plate relative to the clutch hub.

The other features in construction, operation and effects of the second embodiment are similar to those of the first embodiment, and thus will not be explained again.

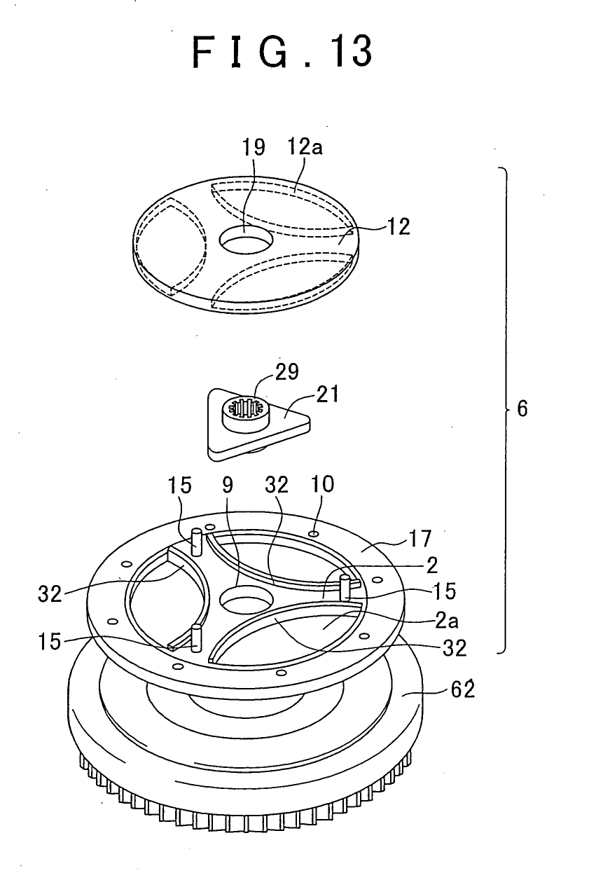

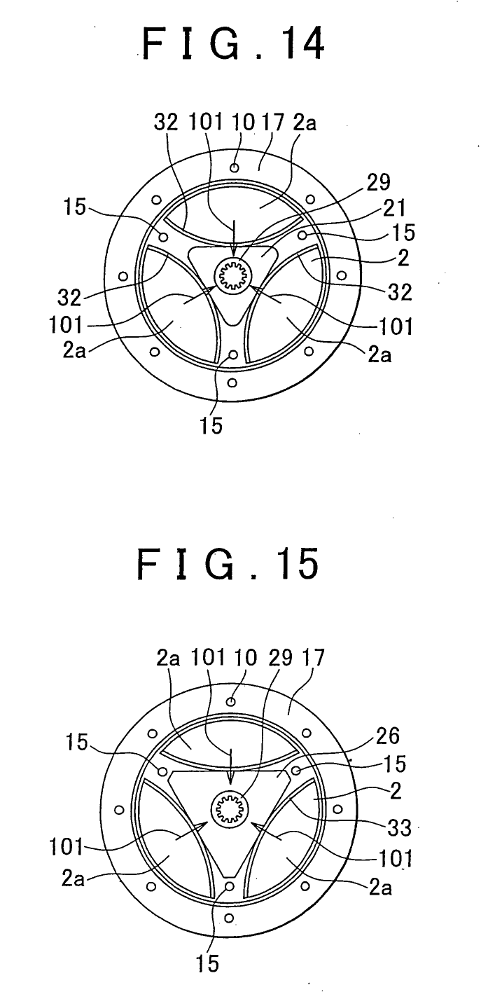

Referring next to FIG. 13 and FIG. 14, a power transmission device according to a third embodiment of the invention will be described. The power transmission device of this embodiment is in the form of a clutch disc of a clutch device installed on an automobile. The clutch disc of this embodiment differs from that of the first embodiment in terms of the construction of pressure members for pressing the clutch hub.

FIG. 13 is an exploded, perspective view showing a clutch disc according to the present embodiment and a flywheel. The clutch disc 6 of this embodiment includes a disc plate 2. The disc plate 2 has recesses 2a formed in its surface opposite to a surface that faces and contacts the flywheel 62. The clutch disc 6 of this embodiment has three pressure members 32.

The pressure members 32 are in the form of plates. More specifically, each of the pressure members 32 consists of a plate spring (or leaf spring). The pressure member 32 is curved or bowed radially inward (i.e., toward the center of the disc plate 2) when viewed from the top in FIG. 13. The pressure members 32 are placed in the disc plate 2 so as to extend along side walls of the recesses 2a. The pressure members 32 are positioned. so as to face the respective sides of the planar shape (e.g., triangle) of the clutch hub 21.

The clutch disc according to the present embodiment further includes a disc plate 12. The disc plate 12 has recesses 12a corresponding with the recesses 2a of the disc plate 2. In this embodiment, the disc plate 12 has the same shape as the disc plate 2. The pressure members 32 are placed in the space formed by the recesses 2a and the recesses 12a.

FIG. 14 is a schematic plan view showing the clutch disc of the present embodiment in which the clutch hub is placed in the disc plates (only one of which is illustrated in FIG. 14). FIG. 14 shows the clutch hub when placed in the neutral position. The clutch hub 21 of this embodiment is in the shape of a generally regular triangle as viewed in the plane of FIG. 14.

In the present embodiment, the pressure members 32 press the end faces of the clutch hub 21 corresponding with respective sides of the triangle as the planar shape of the clutch hub 21, as indicated by arrows 101 in FIG. 14. The pressure members 32 press the clutch hub 21 in radial directions toward the center of rotation of the disc plate 2. The pressure members 32 are arranged at substantially equal intervals, along the circumferential direction of the disc plate 2.

In the clutch disc of the present embodiment, the pressure members are simply constructed. In this embodiment, the pressure members include plate springs, and the plate springs directly press the clutch hub. However, the pressure members are not limited to this form or configuration. For example, each pressure member may include a plate spring portion and a contact portion disposed at a distal end of the plate spring portion, and the contact portion may be arranged to contact with the clutch hub.

In the clutch disc of the present embodiment, too, when the power input member receives torque that has a magnitude smaller than that of power or torque that causes the pressure members to override the corresponding corners of the clutch hub, the received torque is transmitted to the power output member. On the other hand, when the disc plate receives torque large enough to cause the pressure members to override the corresponding corners of the clutch hub, the disc plate rotates relative to the clutch hub, and thus functions as a torque limiter. Also, the clutch disc of this embodiment has stepless twisting characteristics.

The twisting characteristics obtained when the disc plate rotates relative to the clutch hub may be set to desired characteristics by selecting or adjusting the shape of the clutch hub, the size of the clutch hub, the shape of the plate springs as pressure members, and the elasticity of the plate springs.

The other features in the construction, operation and effects of the third embodiment are similar to those of the first and second embodiments, and thus will not be explained again.

Referring next to FIG. 15, a power transmission device according to a fourth embodiment of the invention will be explained. The power transmission device of this embodiment is in the form of a clutch disc of a clutch device installed on an automobile. The clutch disc of this embodiment is different from that of the third embodiment in terms of the construction of the clutch hub and pressure members.

FIG. 15 is a schematic plan view of the clutch disc of the present embodiment in which a clutch hub is mounted in a disc plate. The clutch disc of this embodiment has a clutch hub 26. The clutch hub 26 is in the shape of a generally regular triangle as viewed in the plane of FIG. 15. Each corner of the triangle as the planar shape of the clutch hub 26 is located close to the outer periphery of the disc plate 2.

The clutch device according to the present embodiment has pressure members 33 in the form of plate springs. In the clutch disc of this embodiment, rotation of the disc plate 2 relative to the clutch hub 26 is restricted. In the clutch disc of this embodiment in which the clutch hub 26 is relatively large in size, the pressure members 33 cannot override the corresponding corners of the clutch hub 26.

The clutch disc of the present embodiment functions to stop the clutch hub. Even if the power input member receives relatively large power or torque, the entire torque thus received is transmitted to and generated from the power output member.

The other features in construction, operation and effects of the fourth embodiment are similar to those of the first through third embodiments, and thus will not be explained again.

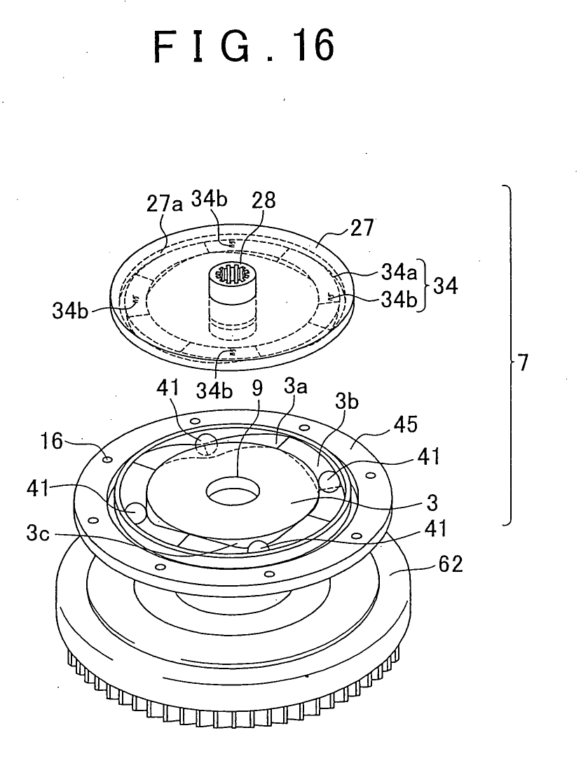

Referring next to FIG. 16 through FIG. 22, a power transmission device according to a fifth embodiment of the invention will be explained. The power transmission device of this embodiment is in the form of a clutch disc of a clutch device installed on an automobile.

FIG. 16 is an exploded, perspective view showing a first example of clutch disc according to the present embodiment and a flywheel. A clutch disc 7 as the first clutch disc of this embodiment includes a disc plate 3. The clutch disc 7 also includes a stacked assembly 45 of a clutch lining, a disc spring and a clutch lining, which are stacked in this order. The stacked assembly 45 is fixed to the disc plate 3.

The disc plate 3 has a recess 3a. The recess 3a is formed in the surface of the disc plate 3 that is opposite the surface contacting the flywheel 62. The recess 3a has an annular shape as viewed from the top in FIG. 16. The disc plate 3 has guide walls 3c, which provide sidewalls of the recess 3a.

The recess 3a has an undulating portion 3b, which provides a bottom face of the recess 3a. The undulating portion 3b is shaped like a band or a ring, and extends in the circumferential direction of the disc plate 3. The undulating portion 3b is formed in the surface of the disc plate 3 that faces a clutch hub 27. The undulating portion 3b is formed with varying height, namely, the height or level of the undulating portion 3b continuously varies along the circumferential direction of the disc plate 3, such that high-level portions and low-level portions are arranged alternately in the circumferential direction.

The clutch disc 7 according to the present embodiment includes rolling members (ball bearings) 41 serving as transmitting members for transmitting power. Each of the ball bearings 41 of this embodiment is in the shape of a sphere, and is able to roll on the surface of the disc plate 3. The ball bearings 41 are received in the recess 3a, and are placed on the surface of the undulating portion 3b. The recess 3a is formed such that the ball bearings 41 can move in regions interposed between the guide walls 3c.

The clutch disc 7 of the present embodiment includes a clutch hub 27 having a disc-like shape. The clutch hub 27 has a recess 27a formed in its surface that is opposed to the disc plate 3.

The clutch disc 7 of the present embodiment includes a pressure member 34 for pressing the ball bearings 41. The pressure member 34 may function as transmitting members for transmitting power, together with the ball bearings 41. The pressure member 34 is disposed in the recess 27a of the clutch hub 27. The pressure member 34 has an annular contact portion 34a. The contact portion 34a is in the form of a plate, which is shaped like a band or ring similar to the undulating portion 3b. The pressure member 34 includes elastic portions 34b having elastic bodies. The elastic portions 34b bias the contact portion 34a toward the disc plate 3. The clutch hub 27 has a shaft receiving portion 28.

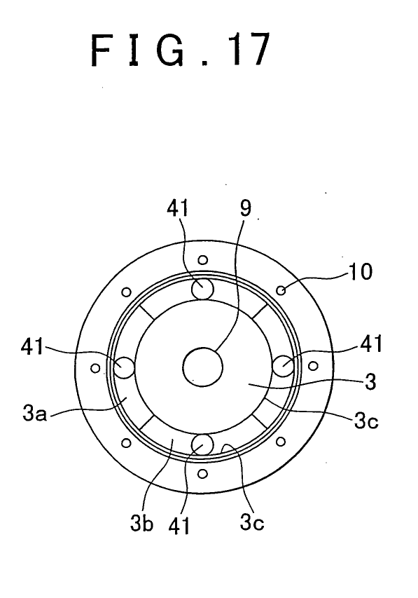

FIG. 17 is a schematic plan view showing the disc plate 3 of the clutch disc 7 of the present embodiment in which the ball bearings 41 are placed. FIG. 17 shows a condition in which the clutch hub 27 is placed in the neutral position with respect to the disc plate 3.

In the condition as shown in FIG. 17, the ball bearings 41 are placed in the low-level portions of the undulating portion 3b. In the present embodiment, bottom portions having the lowest level in the undulating portion 3b are formed at equal intervals along the circumferential direction of the disc plate 3 when viewed in the plane of FIG. 17. In this embodiment, four bottom portions are arranged at equal intervals of approximately 90°, namely, adjacent ones of the bottom portions are spaced from each other by an angle of about 90°. Top portions having the highest level in the undulating portion 3b are disposed at about the midpoint position between adjacent ones of the bottom portions. as viewed in the circumferential direction of the disc plate 3. The top portions are formed at equal intervals along the circumferential direction of the disc plate 3 when viewed in the plane of FIG. 17. In this embodiment, the top portions are formed at intervals of approximately 90°.

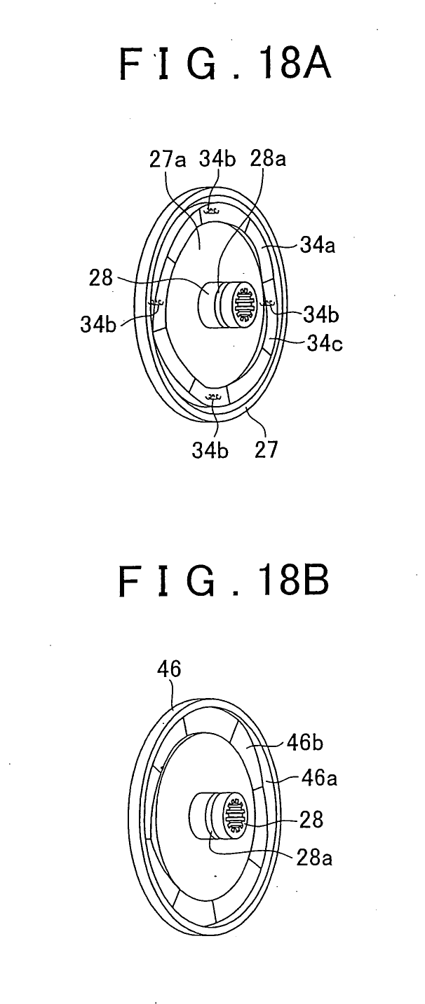

FIG. 18A is a schematic perspective view of the clutch hub 27 of the present embodiment, when viewed from the side on which the recess 27a is formed. The recess 27a of the clutch hub 27 has a circular shape as viewed in the plane of the hub 27. The elastic portions 34b of the pressure member 34 are joined to the bottom wall of the recess 27a of the clutch hub 27 and the back surface of the contact portion 34a. The contact portion 34a is biased under the bias force of the elastic portions 34b toward the disc plate 3.

The contact portion 34a has an undulating portion 34c formed in its surface facing the undulating portion 3b of the disc plate 3. Thus, the height or level of the surface of the contact portion 34a which contacts with the ball bearings 41, as measured from the bottom of the contact portion 34, continuously varies between high and low levels, when viewed in the plane parallel to the axis of rotation of the clutch hub 27. The undulating portion 34c of the contact portion 34a has high-level and low-level portions that are alternately arranged at substantially the same pitch as those of the undulating portion 3b of the disc plate 3.

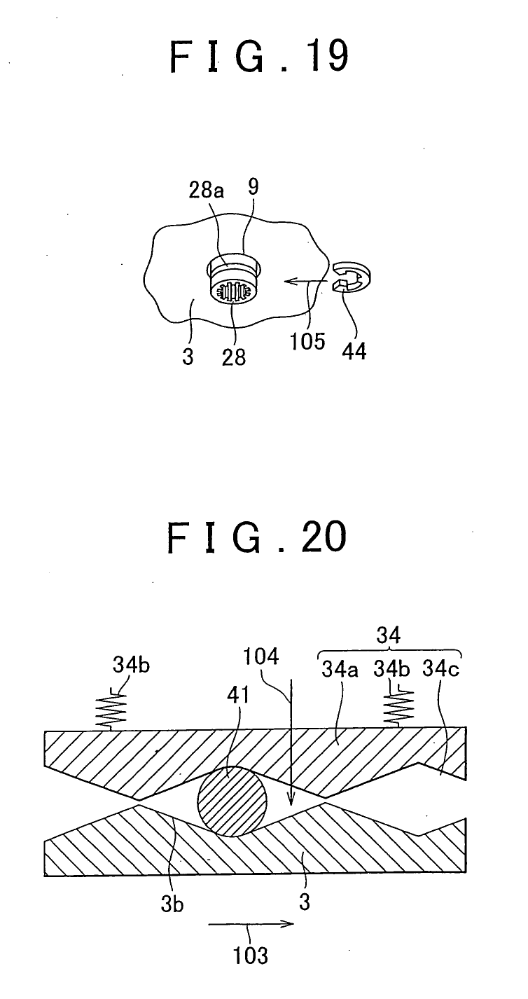

FIG. 19 is an enlarged perspective view showing the shaft receiving portion 28 of the clutch hub 27 of this embodiment and a hub insertion hole of the disc plate 3. The shaft receiving portion 28 of the clutch hub 27 has a groove 28a formed near a distal end thereof. The distal end portion of the clutch hub 27 is exposed to the outside of the disc plate 3. A ring 44 fitted into the groove 28a, as indicated by arrow 105 in FIG. 19, prevents the clutch hub 27 from being pulled out of the disc plate 3.

FIG. 20 is a schematic cross-sectional view showing the clutch disc of the present embodiment when it is cut in the circumferential direction along the undulating portions of the clutch hub 27 and the disc plate 3. FIG. 20 shows a neutral condition in which the low-level portions of the undulating portion 3b of the disc plate 3 are opposed to the low-level portions of the undulating portion 34c of the contact portion 34a, and the ball bearing 41 are placed between the mutually opposed low-level portions.

The undulating portion 3b of the disc plate 3 consists of crests and troughs that are continuously and alternately formed over the circumference thereof. In this embodiment, inclined surfaces of the undulating portion 3b, which provide the crests and troughs, are expressed by straight lines in the section of FIG. 20 taken along the circumferential direction. Namely, the inclined surfaces of the undulating portion 3b are in the form of flat surfaces.

The pressure member 34 presses the ball bearings 41 against the disc plate 3, as indicated by arrow 104 in FIG. 20. Namely, the pressure member 34 presses the ball bearings 41 in a direction in which the disc plate and the clutch hub are opposed to each other (i.e., in a direction parallel to the axis of rotation of the clutch disc). The ball bearings 41 are sandwiched by and between the pressure member 34 and the disc plate 3.

When the disc plate 3 rotates in a direction indicated by arrow 103 in FIG. 20, the ball bearings 41 are pressed between the undulating portions 3b, 34c that are opposed to each other, and the torque is transmitted from the disc plate 3 to the clutch hub 27 via the pressure member 34. In the clutch disc of the present embodiment, when the disc plate receives torque that has magnitude smaller than that of torque that causes the ball bearings to override the corresponding high-level portions of the undulating portion, the torque is transmitted from the disc plate to the clutch hub.

On the other hand, when the disc plate receives torque that causes the rolling members to override the corresponding high-level portions of the undulating portion, the disc plate rotates relative to the clutch hub. Thus, the clutch disc of this embodiment functions as a torque limiter, namely, has the function of preventing transmission of torque that is larger than a predetermined magnitude of torque.

The clutch disc according to the present embodiment provides stepless twisting characteristics expressed by a continuous curve. Also, in the clutch disc of this embodiment, the twisting characteristics may be changed depending upon the pressing force of the pressure member that varies with the relative angle of twist between the disc plate and the clutch hub. Thus, the twisting characteristics of the clutch disc in this embodiment may be adjusted by changing the angle of inclination of the undulating portions, or forming the surfaces of the undulating portions into curved surfaces, or changing the pressing force of the pressure member.

FIG. 18B is a schematic perspective view of a clutch hub of a second example of clutch disc according to the fifth embodiment. The clutch hub 46 has a disc-like shape. The clutch hub 46 has a recess 46a formed in its surface that is opposed to the disc plate 3. The recess 46a has an annular shape and extends along the outer periphery of the clutch hub 46. An undulating portion 46b is formed in the recess 46a. The undulating portion 46b provides a bottom wall of the recess 46a. The rolling members (e.g. ball bearings 41) are disposed in the recess 46a.

In the second clutch disc, the clutch hub 46 itself has elasticity. The annular, undulating portion 46b of the clutch hub 46 serves as a pressure member for pressing the rolling members (ball bearings 41). When the clutch hub 46 is assembled with the disc plate, the clutch hub 46 presses the rolling members (ball bearings 41) against the disc plate, using its own elasticity.

In the present embodiment, both of the disc plate and the pressure member of the clutch hub are formed with undulating portions. With this arrangement, the torque is transmitted from the disc plate to the clutch hub with improved reliability. Alternatively, one of the disc plate and the pressure member may be formed with an undulating portion, and the other may be formed in such a shape that allows power to be transmitted in accordance with the shape of the undulating portion. The pressure member is not limited to the above-described form, but may take any form provided it can press the rolling member (e.g. ball bearing 41).

Each of the undulating portions of the present embodiment includes top portions formed at equal intervals of 90° along the circumferential direction, and bottom portions formed at equal intervals of 90° along the circumferential direction. It is, however, to be understood that the top portions and the bottom portions may be respectively formed at equal intervals of 120° along the circumferential direction. It is also to be understood that the undulating portion is not limited to this form or configuration, but the top portions and bottom portions may be formed at intervals of any desired angle.

While each of the rolling members (ball bearings 41) disposed in the clutch disc is in the shape of a sphere in the present embodiment, the rolling member is not limited to this form, but may take any form provided that it can roll.

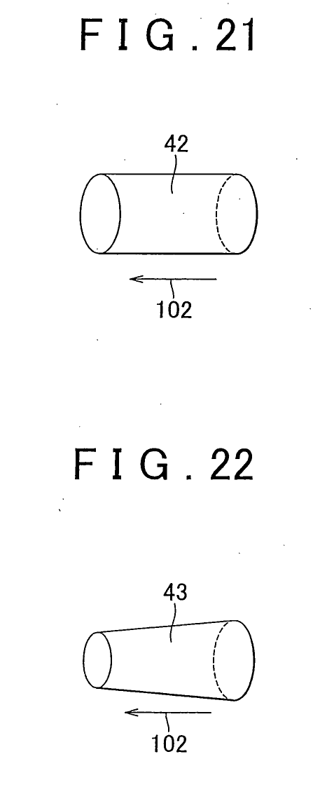

FIG. 21 is a schematic perspective view showing another example of rolling member, which may be employed in the present embodiment. The roller bearing 42 has a cylindrical shape. The roller bearing 42 is placed in the clutch disc with its axis extending in a direction parallel to the direction as indicated by arrow 102 in FIG. 21 which points at the center of rotation of the disc plate.

FIG. 22 is a schematic perspective view showing a further example of rolling member, which may be employed in the present embodiment. The roller bearing 43 is in the shape of a tapered column or truncated cone. The roller bearing 43 is placed in the clutch disc with its axis extending in a direction parallel to the direction as indicated by arrow 102 in FIG. 22 which points at the center of rotation of the disc plate. More specifically, the roller bearing 43 is positioned such that one of its opposite end faces having the smaller diameter faces the center of rotation of the disc plate. The roller bearing 43 thus formed in the shape of a tapered column is able to roll more smoothly between the disc plate and the clutch hub.

The other features, operation and effects of this embodiment are similar to those of the first through fourth embodiments, and thus will not be explained again.

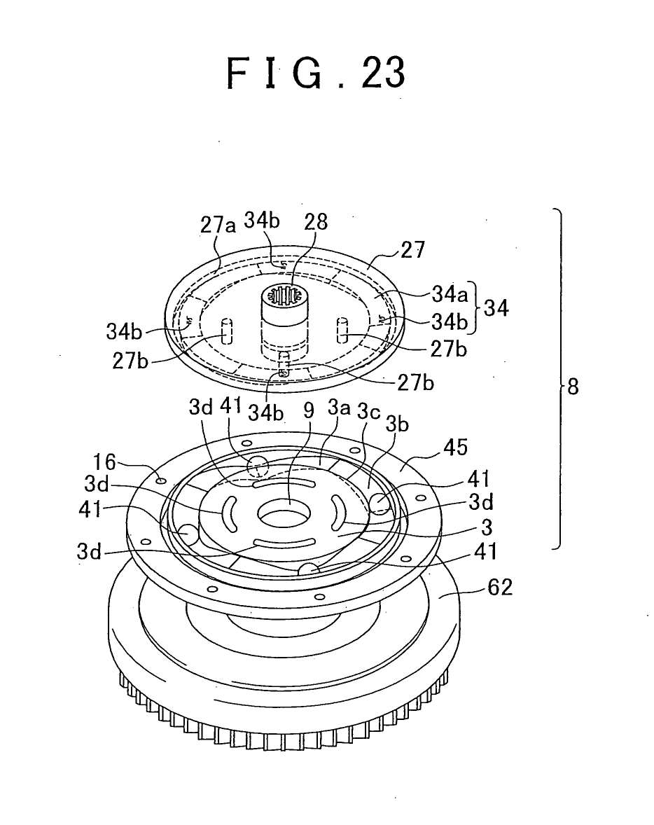

Referring next to FIG. 23, a power transmission system according to a sixth embodiment of the invention will be explained. The power transmission device of this embodiment is in the form of a clutch disc of a clutch device installed on an automobile.

FIG. 23 is an exploded, perspective view showing the clutch disc 8 according to the present embodiment and a flywheel. In the clutch disc 8 of this embodiment, the clutch hub 27 has stopper pins 27b.

The stopper pins 27b protrude upright from the bottom wall of the recess 27a. The stopper pins 27b of this embodiment are arranged at equal intervals along the circumferential direction of the clutch hub 27. The stopper pins 27b are formed at regular intervals of 90° along the circumferential direction. In this embodiment, four stopper pins 27b are formed.

The disc plate 3 of the present embodiment has stopper grooves 3d. The stopper grooves 3d are formed in a surface of the disc plate 3. The stopper pins 27b are inserted into the stopper grooves 3d. The stopper grooves 3d are located in a radially inner region, inside of the recess 3a, of the surface of the disc plate 3. The stopper grooves 3d are formed in respective sectors defined between adjacent top portions of the undulating portion 3b having the highest level. Each of the stopper grooves 3d has a longitudinal direction that extends in the circumferential direction of the disc plate 3. The stopper grooves 3d of this embodiment are arranged at equal intervals along the circumferential direction of the disc plate 3. The stopper grooves 3d are formed at regular intervals of 90° along the circumferential direction. In this embodiment, four stopper grooves 3d are formed.

The clutch disc according to the present embodiment includes a rotation preventing portion that inhibits free rotation of the disc plate 3 relative to the clutch hub 27. The rotation preventing portion has the stopper grooves 3d of the disc plate 3 and the stopper pins 27b of the clutch hub 27. The stopper pins 27b received in the stopper grooves 3d are brought into abutment with end walls of the stopper grooves 3d, to thereby stop rotation of the disc plate 3 relative to the clutch hub 27. The rotation preventing portion of this embodiment is formed so as to prevent the rolling members 41 from overriding the top portions of the undulating portion.

The clutch disc according to the present embodiment functions to stop the clutch hub. When power of a certain magnitude or larger is applied to the power input member, all of the power may be transmitted to and generated from the power output member.

The other features in construction, operation and effects of the present embodiment are similar to those of the first through fifth embodiments, and thus will not be explained again.

In the drawings as mentioned above, the same reference numerals are used for identifying the same or corresponding elements or portions.

While example embodiments of the invention have been described above, it is to be understood that the invention is not limited to details of the described embodiments, but may be embodied with various changes, modifications or improvements, which may occur to those skilled in the art, without departing from the spirit and scope of the invention.

1. A power transmission device comprising:
a power input member that rotates when torque is applied thereto; a transmitting member that transmits the torque applied to the power input member; and a power output member that has substantially the same axis of rotation as the power input member, and outputs the torque applied to the power input member and transmitted by the transmitting member,
wherein the power transmission device has twisting characteristics with which the magnitude of the torque generated from the power output member continuously changes along a curve, with respect to a relative angle of twist between the power input member and the power output member,
wherein the transmitting member is provided in one of the power output member and the power input member, and the transmitting member includes a plurality of pressure members that press the other of the power output member and the power input member, the pressure members being arranged at substantially equal intervals in a circumferential direction of the one of the power output member and the power input member, the pressure members being urged to press the other of the power output member and the power input member in radial directions, such that the magnitude of the torque generated from the power output member varies with the pressing force of the pressure members, which in turn varies with the relative angle of twist between the power input member and the power output member,
wherein the other of the power output member and the power input member is in the shape of a polygon as viewed in the plane thereof, and the pressure members contact sides of the polygon, and
wherein the sides of the polygon of the other of the power output member and the power input member are curved radially inward.

2. (canceled)

3. The power transmission device according to claim 1, wherein the other of the power output member and the power input member has a plurality of comers and a plurality of sides when viewed in a plane thereof, and the pressure members are positioned to contact the respective sides of the other of the power output member and the power input member, and wherein the power input member rotates relative to the power output member when a torque having a magnitude sufficient to cause the pressure members to override the corresponding comers of the other of the power output member and the power input member is applied to the power input member.

4. The power transmission device according to claim 1, wherein the other of the power output member and the power input member has a plurality of comers and a plurality of sides when viewed in a plane thereof, and the pressure members are positioned to contact the respective sides of the other of the power output member and the power input member, and wherein the power transmission device further comprises a rotation preventing portion that inhibits the pressure members from overriding the comers of the other of the power output member and the power input member.

5. The power transmission device according to claim 1, wherein each pressure member includes a contact portion that contacts the other of the power output member and the power input member, and an elastic portion that biases the contact portion toward the other of the power output member and the power input member.

6-7. (canceled)

8. The power transmission device according to claim 1, wherein the pressure members are coil springs or plate springs.

9-12. (canceled)

13. The power transmission device according to claim 1, wherein the power output member is movable in radial directions relative to the power input member, to the extent that the power output member and the power input member rotate about substantially the same axis of rotation.

14. The power transmission device according to claim 1,
wherein the power input member rotates freely relative to the power output member when the power input member receives torque exceeding a predetermined magnitude.

15. The power transmission device according to claim 14, which has twisting characteristics with which the magnitude of the torque generated from the power output member periodically changes with respect to a relative angle of twist between the power input member and the power output member.

16. The power transmission device according to claim 1,
wherein the plurality of pressure members are attached to one of the power output member and the power input member, and presses the other of the power output member and the power input member in radial directions, such that the distance between the axis of rotation and positions where the pressure members contact the other of the power output member and the power input member varies with the relative angle of twist between the power input member and the power output member.

17. (canceled)
